(19) United States
(12) Patent Application Publication
(10) Pub. No.: US 2013/0297486 A1
(43) Pub. Date: Nov. 7, 2013

(54) HYBRID INSTALLMENT-REVOLVING CREDIT METHOD AND SYSTEM

(71) Applicant: Jeffrey A. Colborn, Carlsbad, CA (US)

(72) Inventor: Jeffrey A. Colborn, Carlsbad, CA (US)

(21) Appl. No.: 13/466,012

(22) Filed: May 7, 2012

(51) Int. Cl. G06Q 40/02

(52) U.S. Cl. 705/38

(57) ABSTRACT

A hybrid installment-revolving credit method and system involves establishing a contractually fixed set of payments to be paid on a contractually fixed schedule for each purchase made on the revolving credit line, so that the cost and terms of credit are fixed in the purchase contract and no interest is charged on the balance due. In one embodiment, the method and system involves purchase and immediate installment resale at a markup, with the ownership rights of the purchased goods or services passing through the creditor from the supplier to the purchaser.

### FIELD OF THE INVENTION

This invention relates to methods and systems for supplying and administering revolving credit in a form that involves establishing a contractually fixed set of payments to be paid on a contractually fixed schedule for each purchase made on the revolving credit line, similar to installment credit but without the involvement of conventional interest. In some embodiments, the ownership rights of the purchased goods or services pass through the creditor from the supplier to the purchaser, making the transaction an installment resale with a markup, rather than a loan.

### BACKGROUND

Many systems of credit have been developed over time to accommodate the needs and desires of consumers and businesses. Installment loans for the purchase of specific assets have been around for centuries, evolving from trade on credit arrangements that have existed in one form or another for thousands of years. Today, this type of arrangement is often used as a promotion by merchants in the form of non-revolving “zero-percent financing” sale of capital assets such as cars and furniture, in which the merchant builds the cost of financing into the purchase price. Revolving credit, also not a new concept, took off in the last 50 years with the advent of the credit card. The great advantage of revolving credit is its ability to quickly and easily accommodate unplanned credit needs without opening separate credit contracts in each case: the credit contract takes the form of a “credit line” with a limit.

Credit can be drawn and repaid any number of times against the credit line with minimal documentation and little to no additional credit analysis, making it convenient and efficient even for very small purchases. A disadvantage of revolving credit is its lack of clarity: it can become very difficult or impossible over time to attribute the debts and cash flows to the purchase of specific assets, with only the current balance due and required payment clearly knowable. For example, a consumer may purchase several assets in different months on the same credit card in a given year, incur a late fee in one month and an over-limit fee another month, pay a different interest rate beginning halfway through the year, and take a cash advance near year end. Some assets may still be in his possession, and other debts incurred with the card may have been for consumables such as food and gasoline. When reviewing his year-end obligations and budgeting for the following year, he will have no way of allocating his debt to his asset purchases and therefore no way to reliably plan and control his budget or link his balance sheet items to his financing costs.

This is a chief reason why so many consumers fall into difficulty with credit cards today: they pile up debts and rapidly forget what for, and there is no connection between the useful life of the purchased assets and the term of the credit to enforce discipline in spending. The consumer often accumulates monthly living expenses such as food and gasoline on the card, such that without a significant increase in income it becomes impossible to maintain a similar lifestyle and pay off the debt. The debtor becomes less committed to repaying debt when it continues to collect interest and he can't determine for what he incurred it or the benefits of the financed goods were long ago consumed. In the short-term, the credit customer enjoys the intoxicating freedom of undisciplined purchasing power without worrying about the growing debt or exactly what it is for. The creditor enjoys the delusion of growing projections of guaranteed interest income with the increase of the debt.

The current system for marketing and servicing consumer credit cards is built to take advantage of these human tendencies in order to maximize the amount of credit outstanding and short-term profit for the creditor. For example, credit card rewards programs, “cash back” programs, and initial interest-free periods all are designed to encourage credit customers to maximize their purchases on the card and/or their accumulated debt. However, in the long-term, this system hurts both the credit customer and the creditor and the increased creditor profits are illusory. This is because the lack of clarity and the breaking of the link between asset life and credit term severely degrades the credit customer's discipline in accumulating debt and his willingness to repay the debt in times of trouble, leading ultimately to higher default rates and losses for creditors.

Similar problems occur on a larger scale with business credit. With time, major credit crises can erupt on a national or global scale, leading to reactionary measures, severe credit contraction, and increased government regulation that doesn't solve the root of the problem.

U.S. Pat. No. 7,606,794 to Mancini describes a purchase card system that attempts to partially address the above problems by allowing a purchaser to view a variety of installment payment options at the point of purchase. The purchaser also can see the impact the various scenarios have on his projected monthly payment and obligations to the creditor. However, this system does nothing to clarify on an ongoing basis what portion of the monthly balance and payment is actually associated with each particular purchase, so it does not solve the fundamental clarity problem because, for example, interest rates and payment decisions by the credit customer could change many times between the times the purchase is made and the debt is completely repaid. Further, this system does not obligate the purchaser to stick to any specific repayment plan for each purchase, but merely provides information to the purchaser at the point of sale, which he can ignore, or even if he selects a repayment option, could change any time later. This eliminates clarity of the ultimate cost and schedule of debt repayment. Lastly, it presents the purchaser with a lot of arbitrarily determined information at the point of sale, making it impractical and requiring too much additional information technology infrastructure to deploy, such as purchase kiosks and additional websites. Furthermore, the system as described is limited to application with payment cards.

U.S. Pat. No. 7,472,088 to Taylor et al. describes a system and method for offering a financial product at the point of sale while checking the purchaser's credit data to make an approval decision, but their system does nothing to provide payment options for the purchaser or require a decision thereon. Furthermore, the system as described is limited to application with payment cards.

U.S. Pat. No. 6,681,988 to Stack et al. describes a method and system for managing a transaction card account that allows the credit customer to choose between a pay-in-full charge card functionality and a traditional revolving credit-card functionality. But this division is only made as a function of the outstanding balance and is not determined on a purchase-by-purchase basis. Any charges not paid in full at the end of the first billing cycle are revolved using traditional interest-bearing credit methods. Furthermore, the system as described is limited to application with payment cards.

U.S. Publication No. 2011/0246368 to Wong et al. describes a method and apparatus for a credit card (revolving credit with interest and a credit limit) that turns into a charge card (pay-in-full at the end of each billing cycle) for any purchases that cause the card-holder to exceed the credit limit on the card. While this method allows for the possibility of either revolving credit or pay-in-full, there is no provision for the credit customer to select which method to use on a purchase-by-purchase basis, and no option for fixed installments on a resale-markup basis without interest. This method therefore does not address the need for clarity of debt allocation. Furthermore, the system as described is limited to application with payment cards.

U.S. Pat. No. 6,681,988 to Stack et al. describes a system similar to that of Wong et al., but with the cardholder able to either revolve or pay in full the balance owed at the end of each billing cycle. This is essentially the practice in use throughout the industry today.

U.S. Pat. No. 6,032,552 to Fleischl et al. describes a method and apparatus for processing combined credit card and debit card transactions with a single payment card.

U.S. Publication No. 2010/0268615 to Rosenberger further describes a financial card having multiple balances and end-user-selected debiting parameters that automatically draws from a mixture of cash and credit accounts using pre-set parameters each time a purchase is made with the card, thus enabling the user to avoid carrying multiple debit and credit cards.

While these methods allows for the possibility of either revolving credit or paying immediately, there is no provision for the credit customer to select which method to use on a purchase-by-purchase basis, and no option for fixed installments on a resale-markup basis without interest. This method therefore does not address the need for clarity of debt allocation. Furthermore, the methods as described are limited to application with payment cards.

U.S. Publication No. 2010/0036770 to Fourez et al. describes a method for allowing a payment cardholder to provide multiple funding sources for a payment card according to a set of pre-defined routing rules. This might include cash accounts and/or credit lines. While this method allows for the possibility of either revolving credit or paying immediately, there is no provision for the credit customer to select which method to use on a purchase-by-purchase basis, and no option for fixed installments on a resale-markup basis without interest. This method therefore does not address the need for clarity of debt allocation. Furthermore, the system as described is limited to application with payment cards.

U.S. Publication Nos. 2009/0259548, 2009/0254478, and 2008/0262919 to Ang et al. describe a system and method for giving a cardholder up to three payment options upon receipt of a billing statement, with one option being early payment wherein the cardholder receives a credit to his account, the second option being to pay in full by the standard due date for the billing cycle, and the third option being to defer payment to the next billing cycle and pay an extra amount. The account maintains a “deferred” balance and an “un-deferred” balance. This system does allow for the cardholder to choose between three payment options on a purchase-by-purchase basis after the time of sale. However, there is no option for fixed installments on a resale-markup basis without interest. Furthermore, there is no linking of the allowed payment option with the useful life of the item purchased or with any other parameter. This method therefore does not address the need for clarity of debt allocation.

U.S. Publication No. 2008/0140579 to Argawal describes a system similar to Fourez et al. and others, with the limitation that it applies only to payments made with travelers' checks.

U.S. Publication No. 2007/0250442 to Hogan et al. describes a system in which a purchase transaction by a cardholder may access an installment loan credit line or a revolving credit line at a financial institution on a case-by-case basis for each purchase. Importantly, this does not exploit advantages of both revolving credit and installment credit applied to every transaction, but rather simply splices a revolving credit line and an installment credit line together. It therefore offers the full advantages of neither and adds additional complexity and barriers to the ability of the debtor to clearly determine on an ongoing basis the sources of his debt. Furthermore, the installment credit feature is still a conventional interest-bearing loan rather than a resale with markup without interest, and there is no linking of the allowed payment option with the useful life of the item purchased. This method therefore does not address the need for clarity of debt allocation.

U.S. Pat. No. 6,360,209 to Loeb et al. and U.S. Pat. No. 6,353,811 to Weissman describe systems for separately billing each item purchased with a payment card so that they are itemized on the bill the cardholder receives at the end of the monthly billing cycle. An object of these references is to minimize unnecessary customer inquiries, particularly regarding remote transactions. However, there is no ongoing monthly breakdown of the accumulated finance charges of each item purchased; the card still employs conventional interest-bearing revolving credit rather than a resale with markup without interest, and there is no linking of the allowed payment option with the useful life of the item purchased. This method therefore does not address the need for clarity of debt allocation and discipline of debt repayment.

U.S. Pat. No. 7,628,319 to Brown et al. describes a method and system for indexing individual items purchased with a payment card so a third-party approver may approve the purchase on an item-by-item basis. However, there is no means for the items to be billed using different payment terms. The card still employs conventional interest-bearing revolving credit rather than a resale with markup without interest, and there is no linking of the allowed payment options with the useful life of the items purchased. This method therefore does not address the need for clarity of debt allocation and discipline of debt repayment.

U.S. Pat. No. 7,398,919 to Cooper describes a system involving a deferred debit card, wherein the cardholder automatically pays for purchases from an interest-bearing account at the end of each monthly billing cycle. This is similar to the practice already in place at some financial institutions (e.g., Morgan Stanley Smith Barney) since at least 2006. While this does allow for deferred purchase without interest, it is limited to one billing cycle, and there is no other allowed payment option. This method therefore does not address the need for clarity of debt allocation and discipline of debt repayment.

Thus, there exists a need for methods and systems of supplying credit and processing payments that provide consumers and businesses with flexible, revolving credit terms while providing the clarity and certainty of debt allocation and future payment requirements lacking in existing revolving credit systems.

### SUMMARY

A hybrid installment-revolving credit method and system is provided that offers advantages over traditional installment loans, revolving credit lines, and credit cards. The method and system involves establishing a contractually fixed set of payments to be paid on a contractually fixed schedule for each purchase made on the revolving credit line, so that the cost and terms of credit are fixed in the purchase contract and no interest is charged on the balance due. This allows the credit customer a precise accounting of the sources of his debt, and precise knowledge of when he will contractually pay off his debt and at what cost, information that is unknowable with a traditional revolving line of credit due to uncertainty in changes in interest rates, future payments, and purchasing patterns. Unlike traditional installment debt, the credit customer's available credit revolves as he makes purchases and pays them off over time. In one embodiment, the method and system involves purchase and immediate installment resale at a markup, with the ownership rights of the purchased goods or services passing through the creditor from the supplier to the purchaser. The method and system described herein reduces uncertainty of investor return while preventing debt accumulation beyond a predetermined level. This protects the credit customer from worsening over-indebtedness, while it mitigates risk to the creditor of default. The method and system may be applied to payment card transactions or to any consumer or commercial purchase transactions.

### BRIEF DESCRIPTION OF THE DRAWINGS

FIG. 1 is a flow chart of an exemplary method for issuing a revolving credit line and managing transactions between a creditor and a business credit customer according to at least one embodiment of the methods and systems described herein.

FIG. 2 is a flow chart of an exemplary method for issuing a revolving credit line associated with a payment card account and managing transactions between a creditor and a consumer credit customer according to at least one embodiment of the methods and systems described herein.

FIG. 3a is a diagram of one possible algorithm for determining the payoff term based on purchase size, according to at least one embodiment of the methods and systems described herein.

FIG. 3b is a diagram of one possible algorithm for determining the payoff term based on merchant type, according to at least one embodiment of the methods and systems described herein.

FIG. 4a is an example of a monthly billing statement of a credit card account employing the prior art.

FIG. 4b is an example of a monthly billing statement of a credit card account employing an exemplary embodiment of the methods and systems described herein.

### DETAILED DESCRIPTION OF THE EXEMPLARY EMBODIMENTS

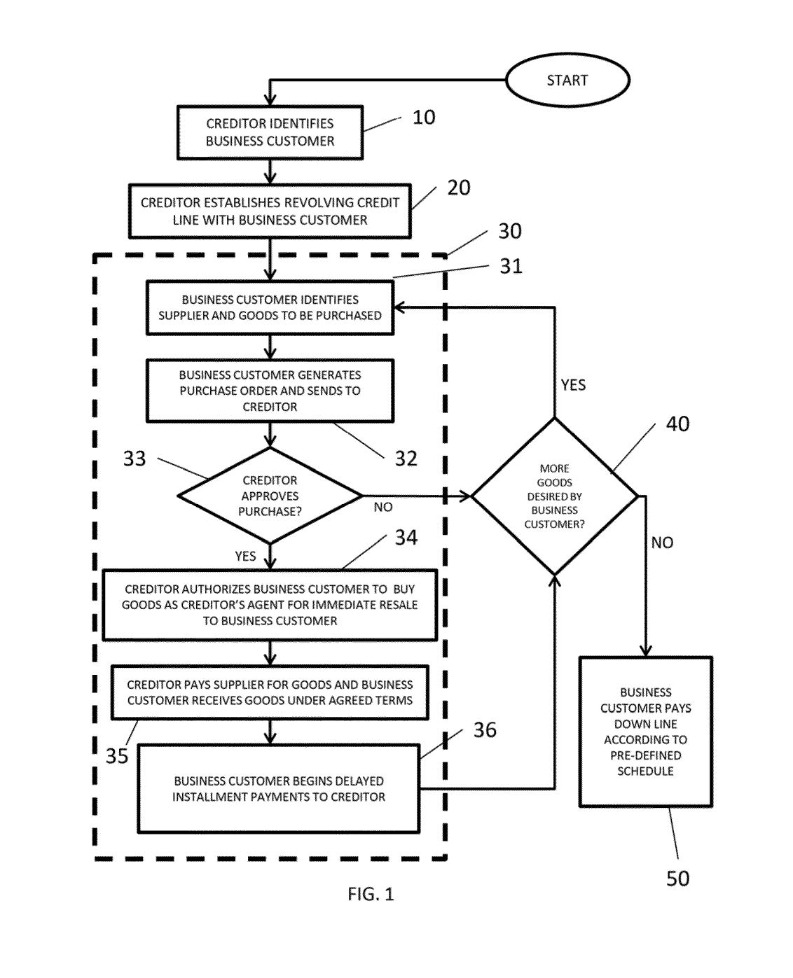

In one embodiment of the methods and systems described herein, a commercial revolving line of credit is supplied to a business for financing the purchase of inventory under an installment resale with markup arrangement. A flow-chart of the method is shown in FIG. 1. The creditor first identifies at 10 a business credit customer seeking financing for the purchase of inventory. The creditor then establishes at 20 a revolving credit facility with the business credit customer by executing a revolving trade credit agreement (“Agreement”) with the business credit customer. The Agreement establishes a credit limit for the sole purpose of purchasing goods from the creditor under a markup sale with installment payment arrangement. The Agreement may include a note evidencing indebtedness and a security agreement providing collateral. It may describe other terms such as representations and warranties, means of payment when due, term of the Agreement, information and inspection rights, indemnifications, default remedies, notices, and other provisions such as may be found in many commercial contracts.

The Agreement specifies that the creditor agrees to purchase goods identified by the business credit customer and resells the goods, usually immediately, to the business credit customer at a markup with payment due later. The Agreement may specify that the business credit customer act as agent for the creditor in making the purchases, and that the business credit customer will not hold the creditor responsible for any defects in the goods or delivery thereof, and will seek remedy only from the supplier from whom the creditor purchased the goods.

The business credit customer then, from time to time as desired, utilizes at 30 the revolving credit line. He first identifies at 31 goods he wants to purchase and their supplier, and creates at 32 a purchase order for the goods and sends it to the creditor for approval, along with payment terms acceptable to the supplier. The purchase order may specify that the business credit customer is buying the goods as agent for the creditor for immediate resale to the business credit customer, and require that the supplier pass through all representations and warranties associated with the goods to the business credit customer. The creditor then approves or rejects at 33 the purchase order and sends it back to the business credit customer. The creditor may reject the purchase order if, for example, the business credit customer is late making payments on previous purchases, the purchase would exceed the credit limit, the business credit customer is in breach of the terms of the Agreement, the supplier or the goods or the supplier's payment or delivery terms are deemed unacceptable by the creditor, or for any other reason. The Agreement may limit the creditor's ability to reject the purchase.

If the purchase is rejected by the creditor, the business credit customer may identify alternative goods, or alternative supplier, or a different quantity, or negotiate different terms with the creditor in order to induce the creditor to approve the next purchase, and the business credit customer can try to repeat process 30.

If the creditor approves at 33 the purchase, he authorizes at 34 the business credit customer permission to act as the creditor's agent in binding the creditor to buy the goods from the supplier under the terms specified and immediately resell them to the business credit customer at an agreed-upon markup with an agreed-upon delay in payment. The creditor then pays at 35 the supplier for the goods and the business customer receives the goods under terms agreed upon.

The business credit customer then begins to make at 36 delayed installment payments to the creditor that total to the agreed upon marked-up resale price of the goods. Payment can be established to be one delayed installment or multiple delayed installments. The Agreement may specify the amount of markup and payment schedule to be applied to each purchase, or these terms may be specified on a case-by-case basis with each purchase order. If there is remaining credit on the revolving line, the business credit customer may then re-initiate process 30 if desired by identifying additional goods to be purchased. Otherwise, he may pay down at 50 the credit line according to the payment schedule agreed upon in step 36 summed over any remaining payments.

In order to maintain the desired clarity of the allocation of the debt to the various goods purchased under the Agreement, reduce uncertainty of investor return, and/or prevent debt accumulation beyond the credit limit, no payment or debt adjustments are permitted for early or late payment, so that the amount owed to the creditor for the goods can never change, except by negotiation or in cases of error or dispute. However, the creditor may seek reimbursement of reasonable collection costs in the case of late payment. The entire method of FIG. 1 may be performed using computer processors, electronic communications, and electronic storage. For example, the creditor and/or customer may communicate with one another, the supplier(s), and/or other parties using one or more electronic and/or computing devices, such as a tablet computer, a mobile, smart, and/or cellular telephone, a personal digital assistant, a wi-fi device, a desktop computer, a laptop computer, an interactive television, a kiosk, and the like, capable of communicating via a telecommunications network, which may include a wide area network, a local area network, an intranet, a wireless network, and/or a telephony network, e.g., via the Internet. Alternatively, the methods herein may be performed using handshakes and oral communication or using any other available devices or systems, such as those disclosed in the references identified elsewhere herein, the entire disclosures of which are expressly incorporated by reference.

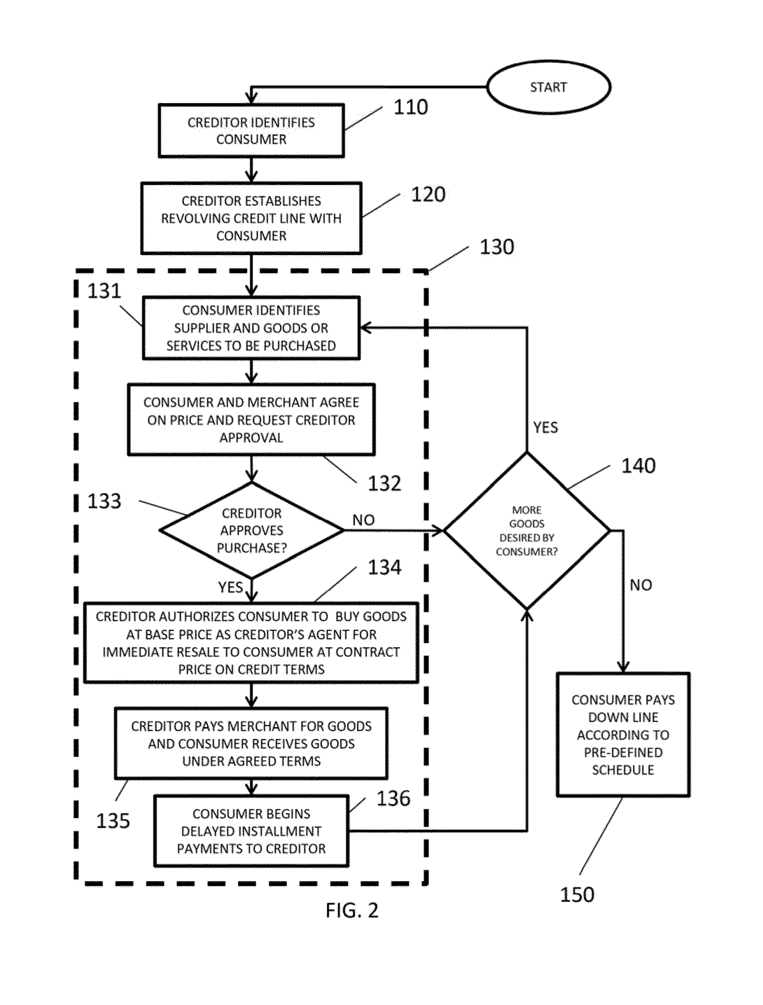

In a second exemplary embodiment of the methods and systems described herein, a payment card is supplied by a card issuer to a consumer for making consumer purchases of goods and services under an installment resale with markup arrangement, where the card issuer is the creditor, the merchant is the supplier of the goods or services to be purchased, and the consumer or cardholder is the credit customer. A flow-chart of the method is shown in FIG. 2.

The card issuer first identifies at 110 a consumer seeking a payment card with the optional ability to purchase on credit. The card issuer then establishes at 120 a revolving credit facility with the consumer by executing a revolving consumer credit agreement (“Cardholder Agreement”) with the consumer. The Cardholder Agreement establishes a credit limit for the sole purpose of purchasing goods or services from the card issuer under a markup resale with installment payment arrangement. The Cardholder Agreement may describe terms such as representations and warranties, means of payment when due, term of the Agreement, default remedies, notices, and other provisions such as may be found in many similar cardholder agreements.

The Cardholder Agreement may specify that the card issuer agrees to purchase goods or services identified by the consumer, from a merchant identified by the consumer, and resell the goods or services, usually immediately, to the consumer at a higher “Contract Price” with payment due later. The “Cost Price” at which the card issuer purchases the goods or services from the merchant may be lower than the “Base Price” agreed to by the merchant and the consumer, by agreement between the card issuer and the merchant. The Cardholder Agreement may specify the difference between the Contract Price and the price displayed by the merchant to the consumer (the explicit markup) under various conditions such as payment schedule, purchase size, payment history, and/or type of goods or service.

Optionally, the cardholder may be offered various options for payment, with different explicit markups, at the point of sale or upon presentation of the next periodic billing statement following the purchase. The Cardholder Agreement may specify that the consumer act as agent for the card issuer in making the purchases, and that the consumer will not hold the card issuer responsible for any defects in the goods or services or delivery thereof, and will seek remedy only from the merchant from whom the consumer purchased the goods or services, or the manufacturer of the goods. However, the Cardholder Agreement may allow for the card issuer to warranty the goods or services to some degree, in addition to any warranties provided by the merchant or manufacturer of the goods.

The consumer then, from time to time as desired, utilizes at 130 the revolving credit line. He first identifies at 131 goods or services he wants to purchase and the merchant supplying them, and agrees at 132 with merchant on the Base Price and sends it to the creditor for approval, along with payment, delivery, and warranty terms acceptable to the merchant. The agreement between the merchant and creditor may specify that the consumer is buying the goods as agent for the creditor for immediate resale to the consumer, and require that the merchant pass through all representations and warranties associated with the goods to the consumer.

The creditor then approves or rejects at 133 the purchase and notifies the merchant. The creditor may reject the purchase if, for example, the consumer is late making payments on previous purchases, the purchase would exceed the credit limit, the consumer is in breach of the terms of the Agreement, the merchant or the goods or the merchant's payment or delivery terms are deemed unacceptable by the creditor, or for any other reason. The Cardholder Agreement may limit the creditor's ability to reject the purchase. If the purchase is rejected by the creditor, the consumer may restore his credit with the creditor by making required payments, or he may identify alternative goods, an alternative merchant, or a different quantity, or negotiate different terms with the creditor in order to induce the creditor to approve the next purchase, and the consumer can try to repeat at 140 process 130.

If the creditor approves at 133 the purchase, he authorizes at 134 the consumer to act as the creditor's agent in binding the creditor to buy the goods from the merchant under the terms specified and immediately resell them to the consumer with an agreed-upon markup with an agreed-upon delayed payment schedule. Alternatively, based on terms specified in the Cardholder Agreement, the creditor and consumer may agree upon the Contract Price and payment schedule at a later time, prior to the consumer making his first payment to the creditor for the purchase. The creditor then pays at 135 the merchant for the goods and the consumer receives the goods or services under the agreed upon terms.

The consumer then begins to make at 136 delayed installment payments to the creditor that total to the agreed upon marked-up resale price of the goods or services (the “Contract Price”). Payment can be established to be one delayed installment or multiple delayed installments. The Agreement may specify the amount of markup and payment schedule to be applied to each purchase, or these terms may be specified on a case-by-case basis with each purchase order. If there is remaining credit on the revolving line, the consumer may then re-initiate process 130 if desired by identifying additional goods or services to be purchased. Otherwise, he may pay down at 150 the credit line according to the payment schedule agreed upon in step 136 summed over any remaining payments. In order to maintain the desired clarity of the allocation of the debt to the various goods purchased under the Agreement, reduce uncertainty of investor return, and prevent debt accumulation beyond the credit limit, no payment or debt adjustments are permitted for early or late payment, except that the creditor may seek reasonable collection costs in the case of late payment. The entire process of FIG. 2 may be performed using computer processors, electronic communications or wireless telecommunications, and electronic storage. It may be performed using mobile communications devices. Or it may be performed using any other available means. This embodiment is illustrated with a consumer as customer but could apply to business, non-profit, or other types of customers as well.

In any of the embodiments of the methods and systems described herein, the Credit Agreement may allow for changes in the markup rates, or “imputed interest rate” for purchases made under the agreement. However, any changes in the markup rate would only apply to subsequent purchases. That is, once the set of payments is determined for a particular purchase and the first of such payments is made, their size or timing cannot be altered, except in cases of error or through negotiations resulting from financial distress or legal demands.

The markup rate for any purchase, or category of purchases, can also be modified by the creditor in the credit customer's favor for promotional purposes. For example, the creditor may for a limited time grant all purchases from a specific merchant or all merchants a zero-percent markup with a payoff term of 12 months “same as cash.” The important difference between this promotion and the typical zero-percent for 12 months promotion under the prior art is that with the methods and systems described herein the credit customer can buy with complete confidence that he will never pay any interest on the purchases he makes under the promotion, while with the prior art, the credit customer must always fear the possibility that he may start paying a great deal of interest beginning in the thirteenth month, or if he is late with an interim payment or fails in some way to adhere to the terms of the Cardholder Agreement.

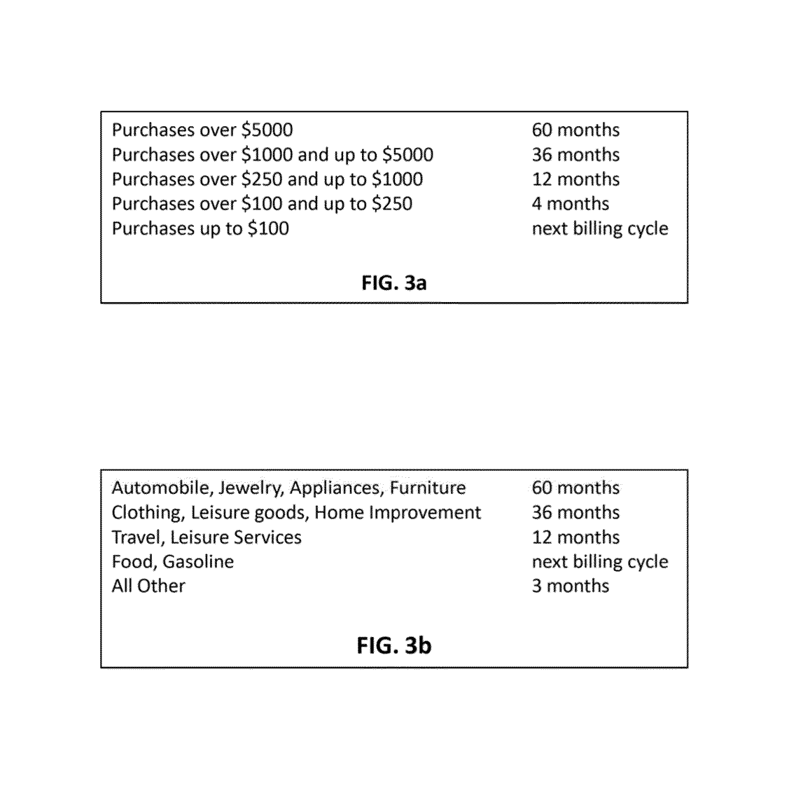

As a part of the methods and systems described herein, a system and process for determining the payoff term for each purchase can be based on a wide variety of algorithms relating to purchase size, merchant type, seasonality, product or service type, or any other relevant and measurable parameters. Upon establishing the revolving credit line at 20 or at 120 a default set of payoff term rules is automatically established. For example, the default payoff term might be 36 months for all purchases except for food and gas, and food and gas purchases would be payable in full at the end of the current billing cycle. A maximum allowable payoff term may be established with the revolving credit line. For example, the revolving credit agreement might specify that the payoff term for any purchase may not exceed 60 months. The creditor may also establish constraints under which the credit customer is allowed to modify the payoff term for each purchase on a case-by-case basis, or modify the payoff term rules. For example, as shown in FIG. 3a, the credit customer may, by communicating with the creditor via an electronic network or by any other means, establish payoff term rules based on purchase size, to be applied to all subsequent purchases, as illustrated in FIG. 3a. Alternatively, the credit customer may establish payoff term rules based on merchant type, to be applied to all subsequent purchases, as illustrated in FIG. 3b.

A wide variety of other rule sets can be envisioned. The credit customer may specify a maximum allowed payment for each billing cycle. He may then specify that at the point of sale, if he tries to make a purchase that will cause his maximum allowed payment to be exceeded, either the purchase is declined or his payoff term rules are overridden for that purchase and the payoff term for that purchase is extended enough (within the maximum allowed payoff term) to keep his payment under the maximum allowed payment for every subsequent billing cycle.

Optionally, the credit customer in this example may specify the payoff term on a case-by-case basis at the point of sale, provided it does not exceed the maximum allowed payoff term and meets other constraints pre-established by the creditor or the credit customer. This may be accomplished by electronic communication between an input device at the point-of-sale (such as a point-of-sale terminal, touch-pad, or mobile communication device) and the creditor's electronic database. In all embodiments, the creditor may contract with another entity to manage some or all aspects of the transactions on the creditor's behalf, including but not limited to managing the electronic database, approving transactions, sending billing statements, communicating with credit customers and suppliers, and managing and operating all of the systems needed to execute the transactions.

Prior to the end of each billing cycle, the credit customer may also optionally be allowed to modify the payoff term for any purchases made during the current billing cycle. This may be performed by electronic communication such as logging in to an account on a website established by the creditor, or by telephone, or any other means. Optionally, the creditor may communicate a summary of charges at the end of each billing cycle and allow a grace period for the credit customer to modify any payoff terms as desired. The grace period should generally be less than two billing cycles so that no changes are made after the credit customer begins payment to the creditor for the given purchase. This is to maintain the desired clarity of debt associated with each purchase, i.e., once the payoff term is established and the Account Holder begins payments on the chosen payoff term for the given purchase, the payoff term should not be modified, except in cases of error or through negotiations resulting from financial distress or legal demands. The payoff term for any purchase, or category of purchases, can also be modified by the creditor in the credit customer's favor for promotional purposes for a limited time. For example, the creditor may grant all purchases from a specific merchant a payoff term of 12 months instead of 3 months.

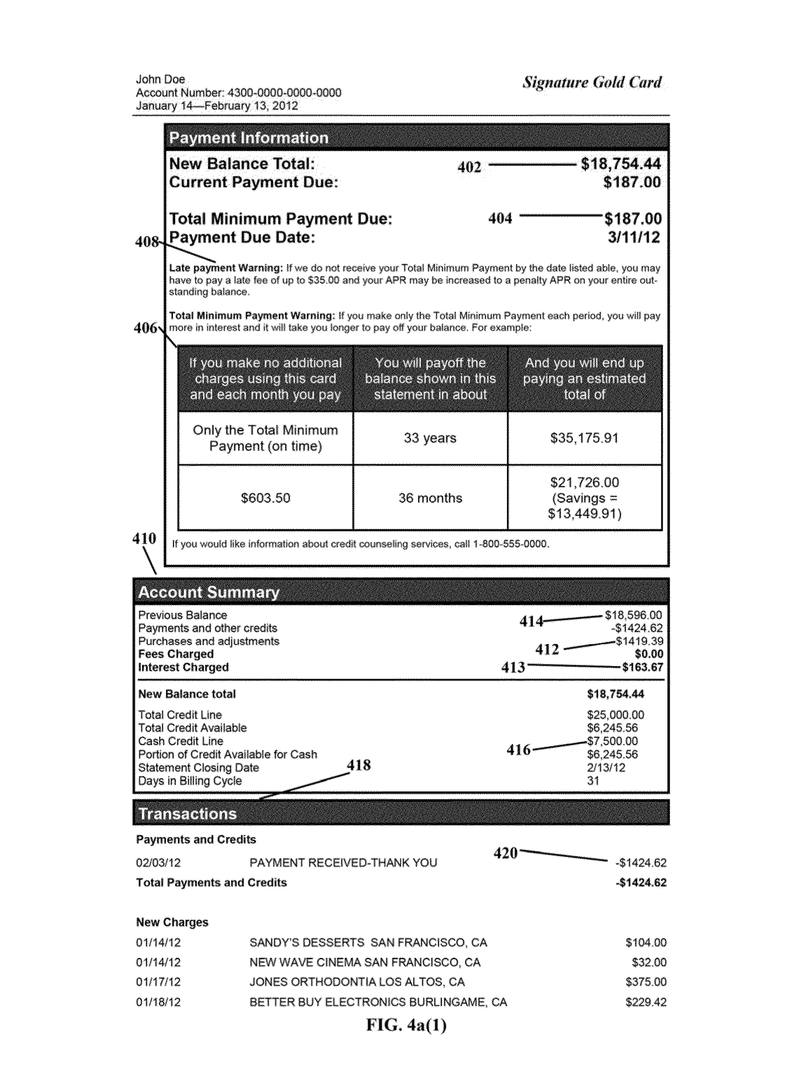

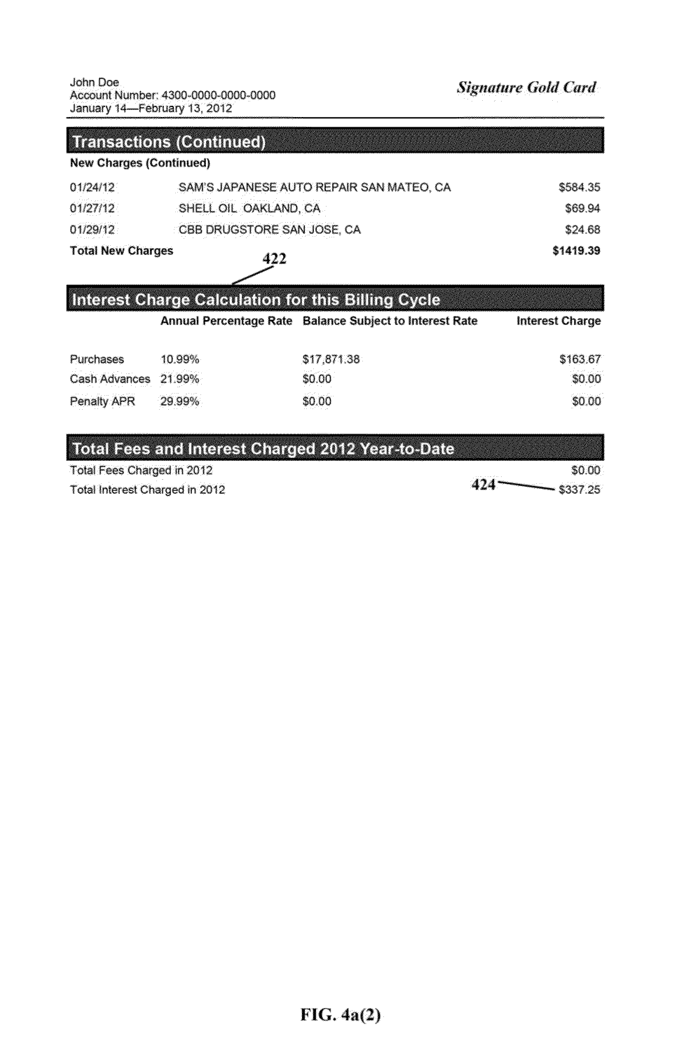

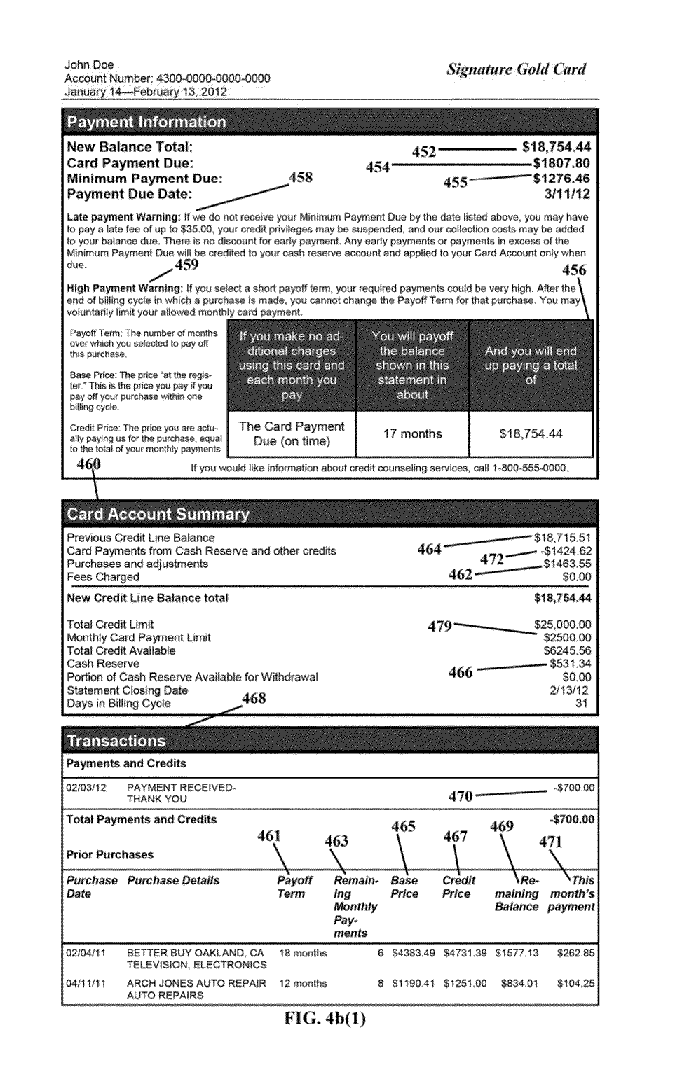

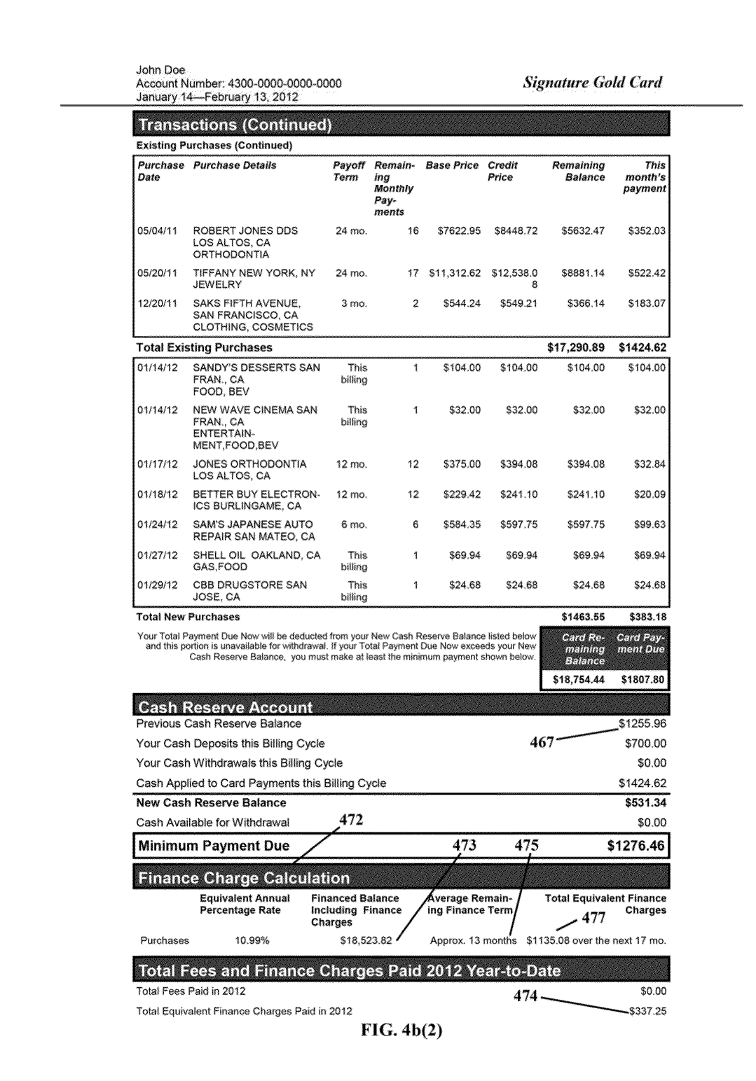

An illustration of the distinction between a second exemplary embodiment of the methods and systems described herein and the prior art is shown in FIG. 4. A typical prior-art monthly credit card statement is shown in FIG. 4a, and a monthly statement for a payment card using the second embodiment of the methods and systems described herein is shown in FIG. 4b. Distinctions immediately become apparent. Note that the current balances at 402 and at 452 on each card are the same, $18,754.44, and the payment due dates are the same. The minimum payment due at 404 on the prior art card is $187, approximately 1% of the outstanding balance and barely enough to cover the interest charges. On the other hand, this exemplary embodiment has a “Card Payment Due” amount at 454 of $1807.80 that is applied to the card account, approximately 10% of the outstanding balance.

Any excess payments over this required payment are credited to a “cash reserve account” on behalf of the cardholder, and any funds in this cash reserve account are owned by the cardholder and are accessible for withdrawal at any time, subject to a hold up to the amount of the next required card payment within 10 days prior to the payment due date. This hold is an optional feature of this embodiment. Note that the “Minimum Payment Due” at 455 equals the “Card Payment Due” at 454 minus the cardholder's current cash reserve at 466. This cash reserve account is an optional feature of this embodiment.

If the cash reserve account is not employed, the cardholder simply is required to make the

Card Payment Due each month. In this exemplary embodiment, any payment above the minimum payment does not reduce the finance charges - there is no contractual provision for paying off the debt early, although this may be accomplished by negotiation and mutual agreement if desired by the cardholder and the creditor.

An advantage of the methods and systems described herein is clarity and certainty of payoff terms. An example of this can be seen by examining the payment scenario tables at 406 and at 456, in which it is assumed for illustration that no additional charges are made on the card. In the prior art, there is no way to know how much the cardholder will spend to ultimately pay off this debt. In the extreme case of making the minimum payment, table at 406 shows that it will take 33 years and cost $35,175.91, and that assumes there will be no changes in interest rate, no late fees, and no penalties. The ultimate cost of the credit to the cardholder is simply unknowable. On the other hand, the table at 456 shows that for this exemplary embodiment, the ultimate cost of the credit to the cardholder is precisely known: it is equal to the current balance on the card.

The late payment warnings at 408 and at 458 are similar for the prior art and this embodiment of the methods and systems described herein in that a late payment fee can be imposed. However, the prior art at 408 allows for continued accumulation of interest on the balance due, and leaves open the possibility of changing the interest rate on purchases already made, a severely punitive measure that is not possible with the methods and systems described herein because the precise payment terms are set contractually as part of the purchase.

In the methods and systems described herein, however, it is allowable for the card issuer to seek to recover his reasonable costs of collection in the case of late payments, including for example, the time and overhead expenses of contacting the cardholder. In this embodiment of the methods and systems described herein, it is illustrative to show a “High Payment Warning” at 459 as well. Because there is no opportunity to modify the term of credit for each purchase after the end of the billing cycle in which the purchase was made, it may be prudent to warn the cardholder that if he selects short payoff terms, he needs to be prepared to make high monthly payments. This is directly related to the fact that if one is to choose a payment term that appears reasonable to most people, for example something less than 36 months in the case of consumer items, then the required monthly payment can be a lot higher than the minimum monthly payments of the prior art.

It should be noted that the prior art cards are generally designed in this way to entice the cardholder into accumulating a lot of debt, within the credit limit, and allowing the cardholder to make small, easy payments over a long period of time in order to maximize the accumulation of interest income for the card issuer at the expense of the cardholder. This embodiment of the methods and systems described herein is in contrast designed to provide reasonable credit with reasonable payoff terms for purchases by the cardholder, with precise clarity as to the sources of the debt and certainty of the time and money required to retire the debt, something that is unknowable with the prior art type of credit card.

To limit the risk of incurring a monthly payment exceeding the cardholder's ability to pay, the cardholder or card issuer may specify a limit at 479 to the allowed Card Payment Due. In this case, any subsequent purchases would be declined if they would result in the total payment due in any future billing cycle exceeding this limit for any payoff term up to the maximum allowed payoff term.

The “Account Summary” sections at 410 of the prior art and at 460 of this exemplary embodiment of the methods and systems described herein further illustrate the distinctions of the methods and systems described herein over the prior art. There are no interest charges in the methods and systems described herein, only installment purchases with a markup. While there is an imputed financing charge with every installment purchase, this charge is fixed and so cannot be seen as conventional interest, which in the prior art at 413 accumulates with each passing day the balance remains outstanding. Note that in the methods and systems described herein, the imputed finance charge in this exemplary embodiment is built into the “Purchases and Adjustments” total at 462 of $1463.55, which represents exactly the same purchases as in the prior art example where the “Purchases and Adjustments” total at 412 of $1419.39 does not include financing costs charged to the cardholder.

In both the prior art and this exemplary embodiment of the methods and systems described herein, the card issuer may by agreement pay the merchant less than the “Base Price” of the purchase, where the Base Price is the price the cardholder negotiates with the merchant and is the price he would presumably pay the merchant if he were to pay cash for the purchase. A fundamental difference between the interest charge at 413 of the prior art and the imputed finance charges of $1463.55−$1419.39=$44.16 included in the Purchases at 462 of the this exemplary embodiment of the methods and systems described herein is that the interest charge at 413 is based on the grand sum of the history of purchases and payments that led to the cardholder's previous monthly balance at 402, whereas the $44.16 portion of at 462 is only based on the cardholders new purchases during the current billing cycle, and the fixed imputed finance charge of prior purchases is included separately in the Previous Balance at 464 in this exemplary embodiment of the methods and systems described herein. Another consequence of this distinction is that with this exemplary embodiment of the methods and systems described herein it is impossible for interest charges to push the balance on the card over the credit limit, an advantage for both the cardholder and the card issuer.

Within 410 in the prior art example there is a Cash Credit Line at 416 from which the cardholder can borrow money for any purpose (even for the purpose of making the minimum required payment back to the card issuer) and which carries a higher interest rate. Borrowing cash is not possible with the methods and systems described herein by design. Instead, a cash reserve balance at 466 is established, which are funds owned by the cardholder. This cash reserve may be accessed at any time using the card to withdraw as cash at automated teller machines, banks, or merchants. Optionally, a portion of the cash reserve up to the minimum payment may be held aside unavailable for withdrawal for a short time prior to the due date for the payment, generally within the same billing cycle and not exceeding 10-20 days. This holding aside enables the cardholder to avoid accidentally spending cash in his reserve that he intended to be automatically used for his required card payment.

Turning to the “Transactions” section at 418 of the prior art example, we see this only lists the “Base Price” of the new transactions along with the purchase dates and merchant names. There is no information describing the source of the current balance, prior transactions, or how much interest is associated with each prior purchase. In fact, the allocation of interest to prior transactions is unknowable because there is no mechanism for allocating payments to the portion of the debt associated with each individual purchase. Furthermore, there is no statement of how much interest will be paid in the future for each purchase made in the current billing cycle. Again, in the prior art example, this is unknowable because it depends on the cardholder's future payment decisions, changes in card interest rates, and purchasing patterns. The cardholder made a payment at 420 of $1424.62 in the prior month in this example.

The “Transactions” section at 468 in this exemplary embodiment of the methods and systems described herein contains all the information the cardholder needs to determine exactly where his current debt came from, what new debt he has incurred, exactly how much finance charge he will pay, and over what period, allocated to each of his purchases. The new charges shown are exactly the same as in the prior art example, but the prior purchases that have not been completely paid off are shown as well. In addition to the information shown in the prior art example, this exemplary embodiment of the methods and systems described herein shows the following for each purchase. The “Payoff Term” at 461 is shown for each purchase, which in this example is fixed at the close of the billing cycle in which the purchase was made. Each Payoff Term at 461 can be selected by a predetermined set of rules by the cardholder by, for example, entries on the card issuer's website, or by any other communication means. Optionally, the predetermined set of rules can be specified by the card issuer. For example, the card issuer may specify that gasoline purchases must be paid in full at the next billing cycle, furniture purchases may be made with payment terms up to 12 months, car repairs may be made with payment terms up to 6 months, etc. Optionally, the card holder may be allowed to select any payment terms, up to a maximum term allowed by the card issuer, for any purchase on a case-by-case basis. This selection may be made at the point of purchase, through the card issuer's website, or by any other communication means, prior to the close of the billing cycle in which the purchases were made. In this example, the Payoff Term for a given purchase may be altered after the close of the billing cycle in which the purchase was made only by negotiation or in the case of errors or disputes. The “Remaining Monthly Payments” at 463 are shown for each purchase. The “Base Price” at 465 shown is the price the cardholder negotiates with the merchant for the purchase. It is the price “at the register” that is shown on the customer receipt issued by the merchant to the cardholder at the point of purchase. In this embodiment, it is the price the cardholder would pay for each purchase if he chooses to pay for that purchase within one billing cycle (upon receipt of his next statement). The “Credit Price” at 467 is the total actual price paid by the cardholder for the purchase, including all imputed finance charges. The Credit Price can never contractually change. The “Remaining Balance” at 469 is the portion of the Credit Price remaining to be paid, and “This Month's Payment” at 471 is the payment due this month for the given purchase. In this example embodiment, the cardholder has made a recent payment at 470 of $700.00, which was insufficient to meet the prior Card Payment at 472 of $1424.62 but this was not a problem because the cardholder had a “Previous Cash Reserve Balance” at 473 of $1255.96, which combined with his $700.00 payment met his required card payment and left him with a Cash Reserve balance at 466 of $531.34. The Remaining Balances at 469 and This Month's Payment at 471 are separately totaled for prior purchases and new purchases and the sum of these gives the Card Remaining Balance at 452 and Card Payment Due at 454. Optionally, the cardholder or card issuer may specify a limit at 479 to the allowed Card Payment Due. In this case, any subsequent purchases would be declined if they would result in the total payment due in any future billing cycle exceeding this limit in this example.

The “Interest Charge Calculation for this Billing Cycle” at 422 shows the various Annual Percentage Rates, balances subject to these interest rates, and interest charges for this billing cycle for the prior art. The “Finance Charge Calculation” section at 472 of this exemplary embodiment of the methods and systems described herein shows analogous but qualitatively different information. The Equivalent Annual Percentage Rate is the same and in the prior art example. In this exemplary embodiment of the methods and systems described herein, this Equivalent Annual Percentage Rate cannot be changed for prior purchases or new purchases shown on the statement. The Financed Balance Including Finance Charges at 473 of $18,523.82 equals the New Balance total at 452 minus the new purchases with a Payoff Term of “This

Billing,” i.e., those new purchases that will be paid off with this month's payment. The Average Remaining Finance Term at 475 of approximately 13 months is a money-weighted average of the remaining number of months at 463 required to pay off each purchase. The Total Equivalent Finance Charges at 477 of $1135.08 is the total of the equivalent finance charges remaining for each purchase, where the equivalent finance charge in a given month for a given prior purchase is assumed to equal the Credit Price at 467 minus the Base Price at 465 divided by the Payoff Term at 461. This gives a higher (more conservative) number than would be obtained using United States Generally Accepted Accounting Principles (USGAAP). Optionally, other accounting methods, including USGAAP, may be used to determine the Finance Charge Calculation at 472.

The “Total Interest Charged in 2012” of $337.25 is shown at 424 in the prior art example, and the “Total Equivalent Finance Charges Paid in 2012” of $337.25 is shown at 474 for this exemplary embodiment of the methods and systems described herein. In this example, both at 424 and at 474 are calculated using USGAAP to illustrate that the finance charges are identical if the balances, payments, and historical purchase patterns are identical, payments are made on time, and the same accounting principles are used. Optionally, other accounting methods and assumptions may be used to determine the Finance Charges Paid at 474.

In all embodiments of the methods and systems described herein, the required calculations may be performed by computer or any other means, communication can take place via electronic or any other means, payments may be made by electronic or any other means, and all data and information required for the implementation of the methods and systems described herein may be stored and accessed via an electronic database or any other means, as is apparent to one skilled in the art.

In summary, the methods and systems described herein offer important advantages over the prior art. The methods and systems described herein have been described in relationship to particular embodiments thereof However, many other variations and modifications and other uses will become apparent to those skilled in the art. The methods and systems described herein should therefore not be limited by the disclosure herein, but only by the following claims.

1. A method for providing credit, comprising:
establishing a revolving credit line between a creditor and a credit customer;
communicating a purchase request to the creditor using a first computing device identifying a product or service to be purchased from a supplier using the revolving credit line;
communicating approval by the creditor of the purchase to the supplier using a second computing device;
creating a financial obligation of the credit customer to the creditor by transferring funds from the creditor to the supplier to pay for the purchase;
arranging for the transfer of the ownership rights of the product or service to the credit customer; and
contractually establishing using a computer processing unit a fixed number of fixed payments to be paid on a fixed schedule by the credit customer to the creditor to discharge the financial obligation, with no crediting or debiting interest charges for early or late payment.

2. The method of claim 1, wherein multiple purchases may be made on the revolving credit line and further comprising:
increasing the balance owed on the revolving credit line by the total of the fixed payments for each purchase;
increasing the total payment required on the revolving credit line in each billing cycle by the amount of the fixed payment due in that billing cycle for each purchase; and
decreasing the balance owed on the revolving credit line by the amount of each payment.

3. The method of claim 1, further comprising the step of transferring the ownership rights of the product or service from the supplier to the creditor prior to arranging the transfer of the ownership rights from the creditor to the credit customer.

4. The method of claim 1, further comprising:
establishing a revolving credit limit;
for each purchase, reducing the credit available on the revolving credit line by the sum of the fixed number of payments established for that purchase; and
for each fixed payment, increasing the credit available on the revolving credit line by the amount of the payment.

5. The method of claim 1, wherein the revolving credit line is a credit card account.

6. The method of claim 1, wherein the billing cycle of the revolving credit line is selected from one of the following:
daily;
weekly;
bi-weekly;
approximately monthly;
approximately quarterly; and
approximately annually.

7. The method of claim 1, wherein the size or number of any contractually established fixed payments is not affected by the actual timing of the receipt of any of the fixed payments by the creditor.

8. The method of claim 1, further comprising the steps of:
establishing a cash reserve account for the credit customer;
crediting to the cash reserve account any payment made by the credit customer to the creditor in excess of the total fixed payments due on the date the payment is received by the creditor; and
debiting from the cash reserve account all fixed payments when due, limited by the available balance in the cash reserve account.

9. The method of claim 8, wherein a portion of the funds in the cash reserve account is not allowed to be withdrawn by the credit customer for a predetermined period prior to the date a payment is due on the revolving credit line.

10. The method of claim 3, wherein the time the ownership rights of the product or service are held by the creditor is greater than zero and less than one second.

11. The method of claim 3, wherein the creditor and supplier transfer all warrantees for the purchased product or service to the credit customer.

12. The method of claim 3, wherein the credit customer agrees prior to the purchase that the creditor bears no responsibility for the product or service.

13. The method of claim 3, wherein the supplier agrees prior to the purchase that the creditor bears no responsibility for the product or service.

14. The method of claim 1, wherein the fixed schedule is determined prior to the credit customer making the first fixed payment, using one of the following steps:
the creditor specifies it based on a set of rules selected by the creditor or the credit customer;
the credit customer specifies it at the time of purchase; or
the credit customer specifies it after the time of purchase.

15. The method of claim 14, wherein the set of rules depends at least in part on one or more of the following parameters:
the nature of the product or service being purchased;
the amount of the purchase;
the type of supplier;
the expected useful life of the product or service being purchased;
the purchasing patterns of the credit customer; and
the credit record of the credit customer.

16. The method of claim 1, wherein the total payment due in each billing cycle is limited by at least one of the following steps:
the credit customer specifies the limit and any subsequent purchase is declined or its payoff term extended if the purchase would otherwise result in the total payment due in any future billing cycle exceeding the limit; and
the creditor specifies the limit and any subsequent purchase is declined or its payoff term extended if the purchase would otherwise result in the total payment due in any future billing cycle exceeding the limit.

17. A system for providing credit, comprising:
a revolving credit line contract between a creditor and a credit customer;
a creditor communication apparatus for receiving a purchase request from the credit customer identifying a product or service to be purchased from a supplier using the revolving credit line and communicating approval by the creditor of the purchase to the supplier;
a database for entering, storing, and retrieving information regarding the purchase and an associated financial obligation of the credit customer to the creditor;
a communication apparatus for arranging the transfer of funds from the creditor to the supplier to pay for the purchase, arranging the transfer of the ownership rights of the product or service to the credit customer, and recording the transfers in the database;
a computer processing unit programmed to compute a fixed number of fixed payments, and a fixed schedule over which the fixed payments are to be made by the credit customer to the creditor to discharge the financial obligation, with no crediting or debiting interest charges for early or late payment.

18. The system of claim 17, wherein the computer processor adds the total of the fixed payments for each purchase to the balance owed on the revolving credit line and stores the resulting sum in the database as the new balance owed, and it subtracts the amount of each fixed payment from the balance owed on the revolving credit line and stores the resulting difference in the database as the new balance owed.

19. The system of claim 17, wherein the database further stores information regarding the transfer of ownership rights of the product or service from the supplier to the creditor prior to their transfer from the creditor to the credit customer.

20. The system of claim 17, wherein the database further stores one or more of the following:
a credit limit;
a maximum payoff term for any purchase; and
a maximum allowed payment for each billing cycle.

21. The system of claim 17, wherein the computer processing unit is programmed to not allow recalculation of the required size or timing of any fixed payment for the purchase by the credit customer after the first fixed payment is made on the purchase.

22. The system of claim 17, wherein the database further stores information regarding a cash account owned by the credit customer and the computer processing unit credits to the cash account any payment made by the credit customer to the creditor in excess of the total fixed payments due on the date the payment is received by the creditor and debits from the cash account all fixed payments when due, limited by the available balance in the cash reserve account.

23. The system of claim 17, wherein the database further stores information regarding the fixed schedule, using one of the following systems:
a computer processor that enters the fixed schedule data into the database using instructions developed from a set of rules created by the creditor;
a computer processor that enters the fixed schedule data into the database using instructions developed from a set of rules created by the credit customer;
a computer processor and communications system that enters the fixed schedule data into the database using instructions received from the credit customer at the time of purchase; or
a computer processor and communications system that enters the fixed schedule data into the database using instructions received from the credit customer after the time of purchase.

24. The system of claim 17, wherein the database stores a maximum allowed payment for each billing cycle and a maximum allowed payoff term for each purchase and the computer processor retrieves the maximum allowed payment from the database and communicates a denial of purchase authorization to the supplier whenever a purchase request is made and the purchase would result in the total payment due in any future billing cycle exceeding the maximum allowed payment or the maximum allowed payoff term.

25. A method for providing credit, comprising:
establishing a revolving credit line with a credit customer;
receiving a purchase request from the credit customer using a first computing device via a network identifying a product or service to be purchased from a supplier using the revolving credit line;
communicating approval of the purchase to the supplier via the network using a second computing device;
creating a financial obligation of the credit customer to the creditor by transferring funds from the creditor to the supplier to pay for the purchase;
arranging for the transfer of ownership rights of the product or service to the credit customer; and
contractually establishing using a computer processing unit a fixed number of fixed payments to be paid on a fixed schedule by the credit customer to the creditor to discharge the financial obligation, with no crediting or debiting interest charges for early or late payment.

26. The method of claim 25, further comprising receiving a series of the fixed payments from the credit customer via the network.

27. The method of claim 1, wherein each fixed payment P=(BP+EM)/N, where BP is the “Base Price” agreed to between the credit customer and the supplier, EM is the “Explicit Markup” agreed to between the credit customer and the creditor, and N is the fixed number of payments agreed to between the credit customer and the creditor.

28. The system of claim 17, wherein each fixed payment P is calculated by the computer processing unit to equal (BP+EM)/N, where BP is the “Base Price” agreed to between the credit customer and the supplier, EM is the “Explicit Markup” agreed to between the credit customer and the creditor, and N is the fixed number of payments agreed to between the credit customer and the creditor.
